(19) United States
(12) Patent Application Publication
(10) Pub. No.: US 2025/0309672 A1
(43) Pub. Date: Oct. 2, 2025

(54) INFORMATION PROCESSING METHOD AND ELECTRONIC DEVICE

(71) Applicant: Lenovo (Beijing) Limited, Beijing (CN)

(72) Inventors: Shuangcheng ZHAO, Beijing (CN); Zhihu WANG, Beijing (CN); Xiaoren CHENG, Beijing (CN)

(21) Appl. No.: 19/085,811

(22) Filed: Mar. 20, 2025

(30) Foreign Application Priority Data
Mar. 29, 2024 (CN) 202410381715.X

(51) Int. Cl. H02J 7/00; H01M 10/44

(52) U.S. Cl. CPC H02J 7/007182; H01M 10/443; H02J 7/0031; H02J 7/007194

(57) ABSTRACT

An information processing method, applied to an electronic device, the electronic device including a battery pack, an anode of the battery pack being a silicon-based anode, includes obtaining a first parameter of the battery pack in the electronic device in a current charge and discharge cycle, the first parameter being at least related to use characteristics of the silicon-based anode; and adjusting a discharge cut-off voltage of the battery pack based on the first parameter of the battery pack in the current charge and discharge cycle.

### CROSS-REFERENCES TO RELATED APPLICATION

This application claims priority to Chinese Patent Application No. 202410381715.X filed on Mar. 29, 2024, the entire content of which is incorporated herein by reference.

### FIELD OF TECHNOLOGY

The present disclosure relates to the field of electronic technology and, more specifically, to an information processing method and an electronic device.

### BACKGROUND

Silicon anode battery is a lithium-ion battery that uses silicon-based materials as the anode. As an emerging anode material, silicon-based materials have attracted much attention due to their theoretical capacity of up to 400 mAh/g to 6t50 mAh/g. Compared with graphite, silicon anode can provide greater energy storage capacity, which is of great significance for promoting the development of electronic devices. However, silicon anode (also referred to as silicon-based anode) batteries face significant volume expansion issues in practical applications. Especially with the increase of silicon content in silicon anode batteries, the swelling issue of silicon anode becomes more and mor serious, which seriously restricts the development of high-density silicon anode batteries.

### SUMMARY

One aspect of this disclosure provides an information processing method applied to an electronic device. The electronic device includes a battery pack, and the anode of the battery pack is a silicon-based anode. The method includes obtaining a first parameter of the battery pack in the electronic device in a current charge and discharge cycle, the first parameter being at least related to use characteristics of the silicon-based anode; and adjusting a discharge cut-off voltage of the battery pack based on the first parameter of the battery pack in the current charge and discharge cycle.

Another aspect of this disclosure provides an electronic device. The electronic device includes a battery pack and a firmware assembly. The anode of the battery pack is a silicon-based anode. The firmware assembly is configured to obtain a first parameter of the battery pack in the electronic device in a current charge and discharge cycle, and adjust a discharge cut-off voltage of the battery pack based on the first parameter of the battery pack in the current charge and discharge cycle. The first parameter is at least related to use characteristics of the silicon-based anode.

Another aspect of this disclosure provides a computer readable storage medium storing computer instructions, when executed by one or more processors, the computer instructions implement the information processing method in the present disclosure.

### BRIEF DESCRIPTION OF THE DRAWINGS

To clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

The structure, scale, size, etc. shown in the drawings of this specification are for the purpose of only matching the content disclosed in the specification for those who are familiar with the technologies to understand and read, rather than limiting the conditions under which the present application is to be implemented, and therefore have no technical significance. Any modification to the structure, change to the scale or the size without affecting the functions and the purpose of the present application shall still fall within the scope covered by the embodiments disclosed in the present application.

FIG. 1 is a flowchart of an information processing method according to some embodiments of the present disclosure.

FIG. 2 is a flowchart of the information processing method according to some embodiments of the present disclosure.

FIG. 3 illustrates the volume expansion of a battery pack at 25° C. as the number of discharges of a battery pack increase under different cut-off voltages.

FIG. 4 is a schematic diagram of curves showing a capacity retention rate of the battery pack as a function of a cumulative number of charge and discharge cycles.

FIG. 5 is a schematic diagram of curves showing a variation of swelling of a battery cell of the battery pack as a function of the cumulative number of charge and discharge cycles.

FIG. 6 is a schematic structural diagram of an electronic device according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It will be apparent to those skilled in the art that various modifications and variations can be made in the present application without departing from the spirit or scope of the application. Accordingly, the present application is intended to cover the modifications and variations of the present disclosure that fall within the scope of the corresponding claims (the claimed technical solution) and their equivalents. The embodiments provided by the embodiments of the present application may be combined with each other when there is no conflict.

To make the objectives, features and advantages of the present disclosure described above more clearly understood, the present disclosure is further described in detail below with reference to accompanying drawings and embodiments.

As described above, silicon anode batteries face significant volume expansion issues (i.e., the swelling issues) in practical applications, especially when the increase of silicon content in silicon anode batteries, the swelling issue of silicon anode batteries has become more and more serious, which has seriously restricted the development of high-density silicon anode batteries.

Accordingly, the present disclosure provides an information processing method that can be applied to an electronic device. The electronic device includes a battery pack, the anode of the battery pack being a silicon-based anode. That is, the battery in the battery is a silicon anode battery. FIG. 1 is a flowchart of an information processing method according to some embodiments of the present disclosure. The method will be described in detail below.

1, obtaining a first parameter of a battery pack in the electronic device in the current charge and discharge cycle, the first parameter being at least related to the use characteristics of the silicon-based anode. It should be noted that one charge and one discharge during the user of the battery pack may be considered as a charge and discharge cycle.

2, adjusting a discharge cut-off voltage of the battery pack based on the first parameter of the battery pack in the current charge and discharge cycle. It should be noted that the discharge cut-off voltage of the battery pack may refer to the lowest operating voltage at which the battery pack should not continue to discharge during the discharge process. That is, the voltage at which the electronic device shuts down.

Consistent with the present disclosure, the discharge cut-off voltage of the battery pack can be adjusted based on the first parameter related to the use characteristics of the silicon-based anode in the battery pack. In this way, the attenuation rate of silicon anode batteries can be slowed down and the risk of swelling of silicon anode batteries can be reduced, thereby increasing the service life of the battery pack.

In some embodiments, adjusting the discharge cut-off voltage of the battery pack based on the first parameter of the battery pack in the current charge and discharge cycle may include increasing the discharge cut-off voltage of the battery pack based on the first parameter of the battery pack in the current charge and discharge cycle to reduce the risk of again and swelling of the battery pack and improve the capacity retention rate and service life cycle of the battery pack. In some embodiments, the capacity retention rate of the battery pack may refer to the percentage of the original capacity that the battery pack can maintain after a certain number of cycles. More specifically, under the same number of cycles, the larger the ratio of the retained capacity to the initial discharge capacity, the greater the capacity retention rate of the battery pack and the better the cycle performance.

It should be noted that during the user of the battery pack, the battery pack attenuation may vary with the use time of the battery pack. Therefore, in some embodiments, if the first parameter meets a first condition, the difference between the value of the first parameter and a first value may be different and the increase of the discharge cut-off voltage of the battery pack may be different such that the discharge cut-off voltage of the battery pack can be adjusted based on the current degree of attenuation of the battery pack. In this way, the attenuation rate of silicon anode batteries can be slowed down, the risk of swelling of silicon anode batteries can be reduced, and the service life of the battery pack can be extended.

In some embodiments, the increase of the discharge cut-off voltage of the battery pack may increase with the increase of the difference between the value of the first parameter and the first value. As the attenuation of the battery pack increases, the adjustment range of the discharge cut-off voltage is increased, thereby effectively slowing down the attenuation rate of the silicon anode battery and further reducing the risk of swelling of the silicon anode battery.

In some embodiments, the increase range of the discharge cut-off voltage of the battery pack may increase linearly with the increase of the difference between the value of the first parameter and the first parameter. In other embodiments, increase range of the discharge cut-off voltage of the battery pack may increase non-linearly with the increase of the difference between the value of the first parameter and the first parameter, which is not limited in the embodiments of the present disclosure and depends on the specific use cases.

In some embodiments, the first parameter may include at least one of an impedance of the battery pack in a first state, a cumulative number of charge and discharge cycles of the battery pack, a cumulative time of the battery pack in a second state, and the number of times the battery pack is in a third state. More specifically, the first parameter may include the impedance of the battery pack in the first state, or the first parameter may include the cumulative number of charge and discharge cycles of the battery pack, or the first parameter may include the cumulative time that the battery pack is in the second state, or the first parameter may include the number of times that the battery pack is in the third state.

In some embodiments, the first parameter may include two of the impedance of the battery pack in the first state, the cumulative number of charge and discharge cycles of the battery pack, the cumulative time of the battery pack in the second state, and the number of times the battery pack is in the third state. For example, the first parameter may include the impedance of the battery pack in the first state and the cumulative number of charge and discharge cycles of the battery pack. Or, the first parameter may include the cumulative number of charge and discharge cycles of the battery pack and the cumulative time of the battery pack in the second state. Or, the first parameter may include the impedance of the battery pack in the first state and the cumulative time of the battery pack in the second state. Or, the first parameter may include the impedance of the battery pack in the first state and the number of times the battery pack is in the third state. Or, the first parameter may include the cumulative number of charge and discharge cycles of the battery pack and the number of times the battery pack is in the third state. Or, the first parameter may include the number of times the battery pack is in the third state and the cumulative time of the battery pack in the second state.

In some embodiments, the first parameter may include three parameters of the impedance of the battery pack in the first state, the cumulative number of charge and discharge cycles of the battery pack, the cumulative time of the battery pack in the second state, and the number of times the battery pack is in the third state. Or, the first parameter may include four parameters of the impedance of the battery pack in the first state, the cumulative number of charge and discharge cycles of the battery pack, the cumulative time of the battery pack in the second state, and the number of times the battery pack is in the third state. The present disclosure does not limit the composition of the first parameter, which can be set based on actual needs.

It should be noted that, in the above embodiment, when the battery pack is in the second state, the voltage of the battery cells in the battery pack may be greater than a first voltage and/or the temperature of the battery cells may be greater than a first temperature. In some embodiments, when the battery pack is in the second state, the voltage of the battery cells of the battery pack may be greater than the first voltage. In this case, the cumulative time that the battery pack is in the second state may be the cumulative time that the battery pack is in the high voltage state. In some embodiments, when the battery pack is in the second state, the temperature of the battery cell in the battery pack may be greater than the first temperature. In this case, the cumulative time that the battery pack is in the second state may be the time that the battery pack is in the high temperature state. In some embodiments, when the battery pack is in the second state, the voltage of the battery cells of the battery pack may be greater than the first voltage, and the temperature of the battery cells of the battery pack may be greater than the first temperature. In this case, the cumulative time that the battery pack is in the second state may be the cumulative time that the battery pack is under high temperature and high voltage.

It should be noted that in the above embodiment, when the battery pack is in the third state, the time during which the operating voltage of the battery pack is lower than the discharge cut-off voltage of the battery pack may not be less than a second preset time. For example, the discharge cut-off voltage of the battery pack is 3.0 volt (V) and the second preset time is 5 seconds (s). When the battery pack is in a state where the operating voltage of the battery pack is less than 3.0 V for no less than 5 s, the battery pack can be considered to be in the third state.

The information processing method provided in the embodiments of the present disclosure is described below with the first parameter including at least one of the impedance of the battery pack in the first state, the cumulative number of charge and discharge cycles of the battery pack, the cumulative time of the battery pack in the second state, and the number of times the battery pack is in the third state.

In some embodiments, when the first parameter includes the impedance of the battery pack in the first state, the first state of the battery pack may be the fully charged state of the battery pack, and the impedance of the battery pack in the first state may be the impedance of the battery pack in the fully charge state. In this way, it is convenient to obtain the first parameter without affecting the user experience, but the present disclosure is not limited hereto. In other embodiments, the first state may also be other states, such as when the battery pack is in the first state, the power of the battery pack is at 70% or 50% or other states.

It should be noted that the impedance R of the battery pack in the first state can be calculated as R=ΔV/I, where ΔV is the voltage change on the battery pack before and after the battery pack is powered off when the battery pack is in the first state, and I is the charging current before the battery pack is powered off when the battery pack is in the first state.

In actual application, the battery pack will automatically enter the power-off state after being fully charged. Therefore, when the first state is the fully charged state of the battery pack, the impedance of the battery pack in the first state may be obtained without user participation. When the first state is other non-full power state, for example, when the first state is the power of the battery pack at 70%, during the charging process of the battery pack, when the battery pack is charged to 70%, the battery pack will not automatically power off. At this time, the user needs to manually cut off the power to the battery pack to obtain the voltage change ΔV on the battery pack before and after the battery pack is powered off when the battery pack is in the first state, which will affect the user experience to a certain extent.

More specifically, during the charging process of the battery pack, when the charging current I of the battery pack drops to Ic (full charge current), the charging switch tube may be turned off, and the electronic device may determine that the current state of the battery pack is fully charged. In this process, the information processing method can detect the change in voltage on the battery pack before and after the switch is turned off ΔV=V−Vfull, and use this to calculate the full charge impedance of the battery pack (i.e., the impedance of the battery pack when it is fully charged) with R=|V−Vfull|/|Ic−0|, where V is the voltage of the battery pack before power is cut off, and Vfull is the voltage of the battery pack after power is cut off.

In some embodiments, the first value may be the impedance of the battery pack when it is in the first state for the first time. In this case, the first condition may be that, during the current charge and discharge cycle, the difference between the impedance of the battery pack in the first state and the first value is greater than a first difference. Take the first state as the fully charged state as an example. The first value may be the impedance of the battery pack when it is in a fully charged state for the first time. In some embodiments, the first condition may include that, during the current charge and discharge cycle, the difference between the impedance of the battery pack when it is fully charged and the first value is greater than the first difference. That is, in this case, during the current charge and discharge cycle, if the difference between the impedance of the battery pack when it is fully charged and the first value is greater than the first difference, the discharge cut-off voltage of the battery pack may be increased to slow down the attenuation rate of the battery pack, reduce the risk of swelling of the silicon anode battery, and extend the service life of the battery pack.

It should be noted that in the above embodiment, during the current charge and discharge cycle, when the difference between the impedance of the battery pack when it is in a fully charged state and the first value is greater than the first difference, the greater the difference between the impedance of the battery pack when it is in a fully charged state, the greater the increase in the discharge cut-off voltage of the battery pack. In this way, the discharge cut-off voltage of the battery pack can be adjusted based on the usage state of the battery pack to slow down the attenuation rate of the battery pack and reduce the risk of swelling of the silicon anode battery.

It should also be noted that the impedance of the battery pack may be related to the temperature of the battery cells, and each time the battery pack is in a fully charged state, the temperature of the battery cells may be different. Therefore, in some embodiments, the comparison of the impedance of the battery pack when it is in a fully charged state with the first value during the current charge and discharge cycle may refer to the comparison of the impedance of the battery pack when it is in a fully charged state with the first value during the current charge and discharge cycle at the same battery cell temperature (e.g., at 25° C.). If the temperature of the battery cell during the current charge and discharge cycle is different from the battery cell temperature when the first value is obtained, there may be a need to convert it into the impedance of the battery pack at the same battery cell temperature and then perform the comparison. In this way, the accuracy of comparison between the impedance of the battery pack when it is in a fully charged state and the first value during the current charge and discharge cycle can be improved.

It should be noted that when converting the impedance of the battery pack in the first state and the impedance of the battery pack in the first state for the first time during the current charge and discharge cycle into the impedance of the battery pack at the same battery cell temperature, the conversion may be performed using a function related to temperature or by querying a database. The present disclosure does not limit the method of converting the impedance, which can be set based on actual needs.

In addition to using the impedance of the battery pack to characterize the usage state of the battery pack, the cumulative number of charge and discharge cycles of the battery pack may also characterize the usage state of the battery pack. In some embodiments, the first parameter may include the cumulative number of charge and discharge cycles of the battery pack. In this case, the first condition may include the cumulative number of charge and discharge cycles of the battery pack being greater than a first number. That is, in some embodiments, during the current charge and discharge cycle, when the cumulative number of charge and discharge cycles of the battery pack is greater than the first number, based on the difference between the cumulative number of charge and discharge cycles of the battery pack and the first number during the current charge and discharge cycle, the discharge cut-off voltage of the battery pack may be adjusted. In this way, the attenuation rate of the battery pack can be slowed down, the risk of swelling of the silicon anode battery can be reduced, and the service life of the battery pack can be extended based on the usage state of the battery pack. In some embodiments, the first number may be zero, or 200 or other values, which is not limited in the embodiments of the present disclosure and can be set based on actual needs.

It should be noted that, based on the foregoing embodiments, in the current charge and discharge cycle, if the cumulative number of charge and discharge cycles of the battery pack is greater than the first number, when the cumulative number of charge and discharge cycles of the battery pack is different, and the discharge cut-off voltage adjustment range of the battery pack may be different. More specifically, the greater the cumulative number of charge and discharge cycles of the battery pack, the greater the adjustment range of the discharge cut-off voltage of the battery pack.

In some embodiments, the first parameter may include the cumulative time that the battery pack is in the second state. In this case, the first condition may include the cumulative time that the battery pack is in the second state being greater than a first preset time. That is, in some embodiments, during the current charge and discharge cycle, when the cumulative time that the battery pack is in the second state is greater than the first preset time, the discharge cut-off voltage of the battery pack may be adjusted based on the difference between the cumulative time that the battery pack is in the second state and the first value during the current charge and discharge cycle. In this way, the attenuation rate of the battery pack can be slowed down, the risk of swelling of the silicon anode battery can be reduced, and the service life of the battery pack can be extended based on the usage state of the battery pack. In some embodiments, the first value may be zero or other values, which is not limited in the embodiments of the present disclosure and can be set based on actual needs.

It should be noted that the present disclosure does not limit the specific value of the first preset time, which depends on the application requirements of the battery pack.

In the foregoing embodiments, during the current charge and discharge cycle, if the cumulative time of the battery pack in the second state is greater than the first preset time, when the cumulative time of the battery pack in the second state is different, the adjustment range of the discharge cut-off voltage of the battery pack may be different. More specifically, during the current charge and discharge cycle, the longer the cumulative time that the battery pack is in the second state, the greater adjustment range of the discharge cut-off voltage of the battery pack.

In some embodiments, the first parameter may include the number of times the battery pack is in the third state. In this case, the first condition may include the number of times the battery pack is in the third state being not less than a second number. That is, in some embodiments, during the current charge and discharge cycle, when the number of times the battery pack is in the third state is greater than the second number, the discharge cut-off voltage of the battery pack may be adjusted based on the difference between the number of times the battery pack is in the third state and the first number during the current charge and discharge cycle. In this way, the attenuation rate of the battery pack can be slowed down, the risk of swelling of the silicon anode battery can be reduced, and the service life of the battery pack can be extended based on the usage state of the battery pack. In some embodiments, the first value may be zero or other values, which is not limited in the embodiments of the present disclosure and can be set based on actual needs.

It should be noted that, based on the foregoing embodiments, in the current charge and discharge cycle, if the number of times the battery pack is in the third state is greater than the second number, when the number of times the battery pack is in the third state is different, the adjustment range of the discharge cut-off voltage of the battery pack may be different. More specifically, the greater the number of times the battery pack is in the third state, the greater the adjustment range of the discharge cut-off voltage of the battery pack.

The following describes the processing procedure of the information processing method when the first parameter includes the number of times the battery pack is in the third state in conjunction with a specific example.

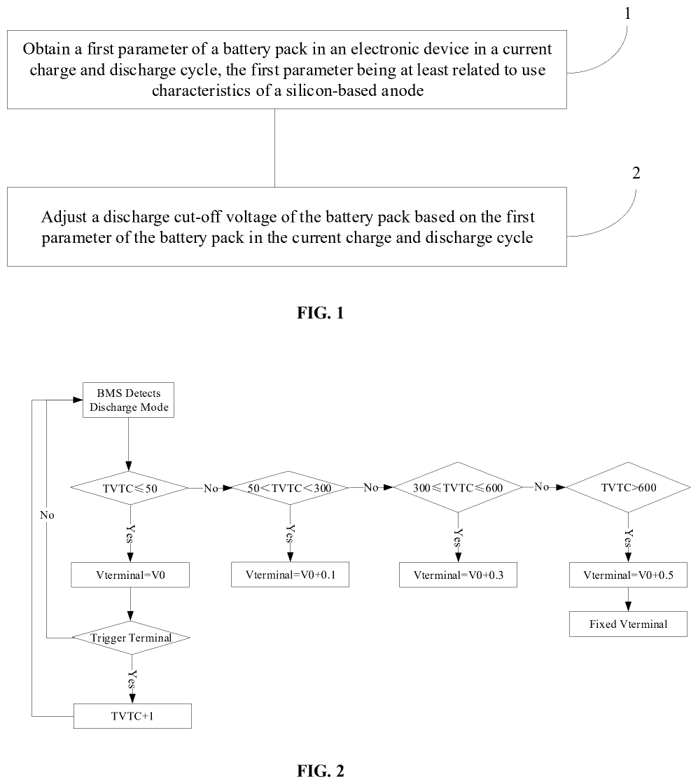

FIG. 2 is a flowchart of the information processing method according to some embodiments of the present disclosure. As shown in FIG. 2, the method includes detecting the discharge state of the battery pack. If the battery pack is in the third state, that is, if the operating voltage of the battery pack is lower than the discharge cut-off voltage and the duration is longer than the second preset time, the number of times the battery pack is in the third state (TVTC) is increased by 1. In addition, if the number of times that the battery pack is in the third state is greater than the second number, such as the second number is 50, the discharge cut-off voltage of the battery pack is increased.

More specifically, in the embodiment shown in FIG. 2, if the number of times the battery pack is in the third state is greater than the second number, increasing the discharge cut-off voltage of the battery pack includes: if the number of times the battery pack is in the third state is greater than the second number and less than a third number, such as greater than 50 and less than 300, the discharge cut-off voltage of the battery pack is increased to a first discharge cut-off voltage. Further, if the number of times the battery pack is in the third state is not less than the third number and not greater than a fourth number, such as not less than 300 and not greater than 600, the discharge cut-off voltage of the battery pack is increased to a second discharge cut-off voltage. Furthermore, if the number of times the battery pack is in the third state is greater than the fourth number, such as greater than 600, the discharge cut-off voltage of the battery pack is increased to a third discharge cut-off voltage.

It should be noted that, in the above embodiment, when the number of times the battery pack is in the third state is not greater than the second number, the discharge cut-off voltage of the battery pack may be the initial discharge cut-off voltage. When the number of times the battery pack is in the third state is greater than the second number, the number of times the battery pack is in the second state may be the time during the current charge and discharge cycle when the operating voltage of the battery pack is less than the discharge cut-off voltage during the current cycle and is not less than the second preset time. The value range of the second preset time may be 5 s to 15 s. The present disclosure does not limit the value range of the second preset time.

The following description takes the initial discharge cut-off voltage as 3.0V and the second preset time as 5 s as an example.

Continue to refer to FIG. 2, the information processing method includes detecting the operating voltage of the battery pack. If the operating voltage of the battery pack is less than the initial discharge cut-off voltage of 3.V for more than 5 s during the current charge and discharge cycle, the number of times the battery pack is in the third state TVTC is increased by 1. The operating voltage of the battery pack continues to be detected. If the number of times the battery pack is in the third state is not greater than 50 times, the discharge cut-off voltage of the battery pack is maintained at the initial discharge cut-off voltage of V0V. At this time, the number of times the battery pack is in the third state is the number of times the operating voltage of the battery pack is less than V.0V for more than 5 s. The operating voltage of the battery pack continues to be detected. If the number of times the battery pack is in the third state is greater than 50 times and less than 300 times, the discharge cut-off voltage of the battery pack is increased to the first discharge cut-off voltage of V0+0.1V. At this time, the number of times the battery pack is in the third state is the number of times the operating voltage of the battery pack is less than V0+0.1V for more than 5 s. The operating voltage of the battery pack continues to be detected. If the number of times the battery pack is in the third state is not less than 300 times and not more than 600 times, the discharge cut-off voltage of the battery pack is increased to the second discharge cut-off voltage of V0+0.3V. At this time, the number of times the battery pack is in the third state is the number of times the operating voltage of the battery pack is less than V0+0.3V for more than 5 s. The operating voltage of the battery pack continues to be detected. If the number of times the battery pack is in the third state is more than 600 times, the discharge cut-off voltage of the battery pack is increased to the third discharge cut-off voltage of V0+0.5V.

In some embodiments, when the discharge cut-off voltage of the battery pack is adjusted to the preset discharge cut-off voltage, the process of adjusting the discharge cut-off voltage of the battery pack based on the first parameter may be exited. As in the above embodiment, when the discharge cut-off voltage of the battery pack is adjusted to V0+0.5V, the discharge cut-off voltage of the battery pack is no longer increased with the increase of the number of times the battery pack is in the third state to avoid charging too frequently and affecting the user experience, but the present disclosure is not limited thereto. In some embodiments, the discharge cut-off voltage of the battery pack may also continue to be adjusted based on the first parameter until it cannot be adjusted anymore.

It should be noted that in FIG. 2, the trigger terminal generally refers to the use of a trigger function in a terminal emulator to automatically execute a specific operation. In the embodiments of the present disclosure, the trigger terminal may refer to the number of times the trigger is triggered to be in the third state plus 1.

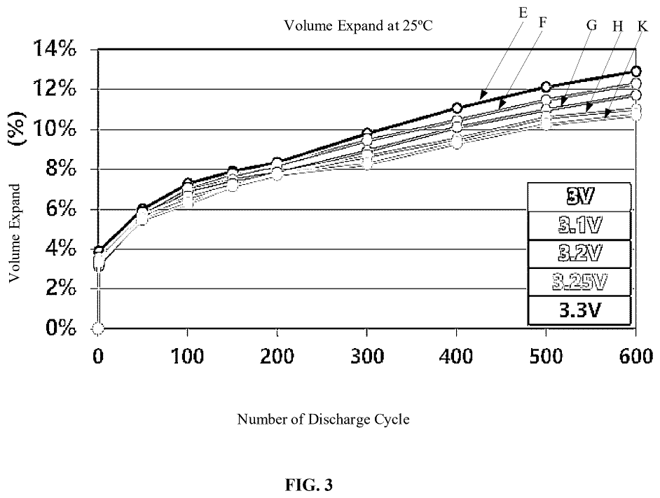

FIG. 3 illustrates the volume expansion of a battery pack at 25° C. as the number of discharges of the battery pack increase under different cut-off voltages. Curve E illustrates the volume expansion of the battery pack at 25° C. as the number of discharges of the battery pack increases when the discharge cut-off voltage is 3.0V. Curve F illustrates the volume expansion of the battery pack at 25° C. as the number of discharges of the battery pack increases when the discharge cut-off voltage is 3.1V. Curve G illustrates the volume expansion of the battery pack at 25° C. as the number of discharges of the battery pack increases when the discharge cut-off voltage is 3.2V. Curve H illustrates the volume expansion of the battery pack at 25° C. as the number of discharges of the battery pack increases when the discharge cut-off voltage is 3.25V. Curve K illustrates the volume expansion of the battery pack at 25° C. as the number of discharges of the battery pack increases when the discharge cut-off voltage is 3.3V.

As shown in FIG. 3, under the same discharge times, the increase in the discharge cut-off voltage of the discharge cut-off voltage can reduce the volume expansion of the battery pack. The more the discharge times, the more the reduction in the volume expansion of the battery pack.

In some embodiments, when the first parameter includes the four parameters of the impedance of the battery pack in the first state, the cumulative number of charge and discharge cycles of the battery pack, the cumulative time of the battery pack in the second state, and the number of times the battery pack is in the third state, the first condition may include at least one of the conditions of: during the current charge and discharge cycle, the difference between the impedance of the battery pack when it is in the first state and the first value is greater than the first value, the first value being the impedance of the battery pack when it is in the first state for the first time; during the current charge and discharge cycle, the cumulative number of charge and discharge cycles of the battery pack is greater than the first number; during the current charge and discharge cycle, the cumulative time that the battery pack is in the second state is greater than the first preset time; during the current charge and discharge cycle, the number of times that the battery pack is in the third state is greater than the second number.

It should be noted that in the foregoing embodiments, during the use of the electronic device, the discharge cut-off voltage of the battery pack may be adjusted if the usage state of the battery pack meets at least one of the four conditions of: during the current charge and discharge cycle, the difference between the impedance of the battery pack in the first state and the first value is greater than the first value, the first value being the impedance of the battery pack when it is in the first state for the first time; during the current charge and discharge cycle, the cumulative number of charge and discharge cycles of the battery pack is greater than the first number; during the current charge and discharge cycle, the cumulative time that the battery pack is in the second state is greater than the first preset time; during the current charge and discharge cycle, the number of times that the battery pack is in the third state is greater than the second number.

In some embodiments, if during the use of the electronic device, the difference between the impedance of the battery pack in the first state and the first value is greater than the first value during the current charge and discharge cycle, the cumulative number of charge and discharge cycles of the battery pack is less than the first number, the cumulative time that the battery pack is in the second state is less than the first preset time, and the number of times that the battery pack is in the third state is less than the second preset time, the discharge cut-off voltage of the battery pack may be adjusted based on the difference between the impedance of the battery pack in the first state and the first value during the current charge and discharge cycle to slow down the attenuation rate of the battery pack and extend the service life of the battery pack.

In some embodiments, if during the use of the electronic device, the difference between the impedance of the battery pack when it is in the first state and the first value is not greater than the first value, the cumulative number of charge and discharge cycles of the battery pack is greater than the first number, the cumulative time that the battery pack is in the second state is less than the first preset time, and the number of times that the battery pack is in the third state is less than the second number, the discharge cut-off voltage of the battery pack may be adjusted based on the cumulative number of charge and discharge cycles of the battery pack during the current charge and discharge cycle to slow down the attenuation rate of the battery pack and extend the service life of the battery pack.

In some embodiments, if during the use of the electronic device, the difference between the impedance of the battery pack when it is in the first state and the first value is not greater than the first value, the cumulative number of charge and discharge cycles of the battery pack is less than the first number, the cumulative time that the battery pack is in the second state is greater than the first preset time, and the number of times that the battery pack is in the third state is less than the second number, the discharge cut-off voltage of the battery pack may be adjusted based on the cumulative time that the battery pack is in the second state during the current charge and discharge cycle to slow down the attenuation rate of the battery pack and extend the service life of the battery pack.

In some embodiments, if during the use of the electronic device, the difference between the impedance of the battery pack when it is in the first state and the first value is not greater than the first value, the cumulative number of charge and discharge cycles of the battery pack is less than the first number, the cumulative time that the battery pack is in the second state is less than the first preset time, and the number of times that the battery pack is in the third state is greater than the second preset time, the discharge cut-off voltage of the battery pack may be adjusted based on the number of times the battery pack is in the third state during the current charge and discharge cycle to slow down the attenuation rate of the battery pack and extend the service life of the battery pack.

In some embodiments, if during the use of the electronic device, the difference between the impedance of the battery pack in the first state and the first value is greater than the first value during the current charge and discharge cycle, the cumulative number of charge and discharge cycles of the battery pack is greater than the first number, the cumulative time that the battery pack is in the second state is less than the first preset time, and the number of times that the battery pack is in the third state is less than the second number, the discharge cut-off voltage of the battery pack may be adjusted based on the difference between the impedance of the battery pack in the first state and the first value during the current charge and discharge cycle. Or, the discharge cut-off voltage of the battery pack may be adjusted based on the cumulative number of charge and discharge cycles of the battery pack during the current charge and discharge cycle to slow down the attenuation rate of the battery pack and extend the service life of the battery pack.

It should be noted that in the foregoing embodiments, when the adjustment range (e.g., the first amplitude) of the discharge cut-off voltage of the battery pack determined based on the difference between the impedance of the battery pack in the first state and the first value during the current charge and discharge cycle is different from the adjustment range (e.g., the second amplitude) of the discharge cut-off voltage of the battery pack determined based on the cumulative number of charge and discharge cycles of the battery pack during the current charge and discharge cycle, the discharge cut-off voltage of the battery pack may be adjusted based on the first amplitude, the second amplitude, or the larger value of the first amplitude and the second amplitude, which is not limited in the embodiments of the present disclosure.

In some embodiments, if during the use of the electronic device, the difference between the impedance of the battery pack in the first state and the first value is greater than the first value during the current charge and discharge cycle, the cumulative number of charge and discharge cycles of the battery pack is less than the first number, the cumulative time that the battery pack is in the second state is greater than the first preset time, and the number of times that the battery pack is in the third state is less than the second preset time, the discharge cut-off voltage of the battery pack may be adjusted based on the difference between the impedance of the battery pack in the first state and the first value during the current charge and discharge cycle, or the cumulative time that the battery pack is in the second state during the current charge and discharge cycle to slow down the attenuation rate of the battery pack and extend the service life of the battery pack.

It should be noted that in the foregoing embodiments, when the adjustment range (e.g., the first amplitude) of the discharge cut-off voltage of the battery pack determined based on the difference between the impedance of the battery pack in the first state and the first value during the current charge and discharge cycle is different from the adjustment range (e.g., the third amplitude) of the discharge cut-off voltage of the battery pack determined based on the cumulative time that the battery pack is in the second state during the current charge and discharge cycle, the discharge cut-off voltage of the battery pack may be adjusted based on the first amplitude, the third amplitude, or the larger value of the first amplitude and the third amplitude, which is not limited in the embodiments of the present disclosure.

In some embodiments, if during the use of the electronic device, the difference between the impedance of the battery pack when it is in the first state and the first value is not greater than the first value during the current charge and discharge cycle, the cumulative number of charge and discharge cycles of the battery pack is greater than the first number, the cumulative time that the battery pack is in the second state is greater than the first preset time, and the number of times that the battery pack is in the third state is less than the second preset time, the discharge cut-off voltage of the battery pack may be adjusted based on the cumulative number of charge and discharge cycles of the battery pack during the current charge and discharge cycle, or the cumulative time that the battery pack is in the second state during the current charge and discharge cycle to slow down the attenuation rate of the battery pack and extend the service life of the battery pack.

It should be noted that in the foregoing embodiments, when the adjustment range (e.g., the second amplitude) of the discharge cut-off voltage of the battery pack determined based on the cumulative number of charge and discharge cycles of the battery pack during the current charge and discharge cycle is different from the adjustment range (e.g., the third amplitude) of the discharge cut-off voltage of the battery pack determined based on the cumulative time that the battery pack is in the second state during the current charge and discharge cycle, discharge cut-off voltage of the battery pack may be adjusted based on the second amplitude, the third amplitude, or the larger value of the second amplitude and the third amplitude, which is not limited in the embodiments of the present disclosure.

In some embodiments, if during the use of the electronic device, the difference between the impedance of the battery pack when it is in the first state and the first value is not greater than the first value during the current charge and discharge cycle, the cumulative number of charge and discharge cycles of the battery pack is greater than the first number, the cumulative time that the battery pack is in the second state is less than the first preset time, and the number of times that the battery pack is in the third state is greater than the second number, the discharge cut-off voltage of the battery pack may be adjusted based on the difference between the impedance of the battery pack in the first state and the first value during the current charge and discharge cycle, or the number of times that the battery pack is in the third state during the current charge and discharge cycle to slow down the attenuation rate of the battery pack and extend the service life of the battery pack.

In some embodiments, if during the use of the electronic device, the difference between the impedance of the battery pack when it is in the first state and the first value is not greater than the first value, the cumulative number of charge and discharge cycles of the battery pack is greater than the first number, the cumulative time that the battery pack is in the second state is less than the first preset time, and the number of times that the battery pack is in the third state is greater than the second number, the discharge cut-off voltage of the battery pack may be adjusted based on the cumulative number of charge and discharge cycles of the battery pack during the current charge and discharge cycle, or the number of times that the battery pack is in the third state during the current charge and discharge cycle to slow down the attenuation rate of the battery pack and extend the service life of the battery pack

In some embodiments, if during the use of the electronic device, the difference between the impedance of the battery pack when it is in the first state and the first value is not greater than the first value, the cumulative number of charge and discharge cycles of the battery pack is less than the first number, the cumulative time that the battery pack is in the second state is greater than the first preset time, and the number of times that the battery pack is in the third state is greater than the second number, the discharge cut-off voltage of the battery pack may be adjusted based on the cumulative time that the battery pack is in the second state during the current charge and discharge cycle, or the number of times that the battery pack is in the third state during the current charge and discharge cycle to slow down the attenuation rate of the battery pack and extend the service life of the battery pack.

In some embodiments, adjusting the discharge cut-off voltage of the battery pack based on the first parameter of the battery pack in the current charge and discharge cycle may include calculating the discharge cut-off voltage of the battery pack using a first function based on the first parameter of the battery pack in the current charge and discharge cycle.

In some embodiments, if the first parameter includes the impedance of the battery pack when it is in the first state, based on the first parameter of the battery pack in the current charge and discharge cycle, using the first function to calculate the discharge cut-off voltage of the battery pack may include adjusting the discharge cut-off voltage of the battery pack using a first sub-function based on the impedance of the battery pack when it is in the first state during the current charge and discharge cycle of the battery pack. In some embodiments, the adjusted discharge cut-off voltage of the battery pack may be calculated using the formula: Vterminal=Vterminal0+f1(Re−Re0), where Vterminal0 is the discharge cut-off voltage when the battery pack is in the first state for the first time, that is, the initial discharge cut-off voltage, Re is the impedance of the battery pack in the first state during the current charge and discharge cycle, Re0 is the impedance of the battery pack when it is in the first state for the first time, and f1 is the first sub-function.

In some embodiments, if the first parameter includes the cumulative number of charge and discharge cycles of the battery pack, based on the first parameter of the battery pack in the current charge and discharge cycle, using the first function to calculate the discharge cut-off voltage of the battery pack may include adjusting the discharge cut-off voltage of the battery pack using a second sub-function based on the cumulative number of charge and discharge cycles of the battery pack during the current charge and discharge cycle. In some embodiments, the adjusted discharge cut-off voltage of the battery pack may be calculated using the formula: Vterminal=Vterminal0+f2(Ccycle), where Vterminal0 is the discharge cut-off voltage of the battery pack during the first charge and discharge cycle, that is, the initial discharge cut-off voltage, Ccycle is the cumulative number of charge and discharge cycles of the battery pack during the current charge and discharge cycle, and f2 is the second sub-function.

In some embodiments, if the first parameter includes the cumulative time that the battery pack is in the second state, based on the first parameter of the battery pack in the current charge and discharge cycle, using the first function to calculate the discharge cut-off voltage of the battery pack may include adjusting the discharge cut-off voltage of the battery pack using a third sub-function based on the cumulative time that the battery pack is in the second state during the current charge and discharge cycle. In some embodiments, the adjusted discharge cut-off voltage of the battery pack may be calculated using the formula: Vterminal=Vterminal0+f3(Thvht), where Vterminal0 is the initial charge and discharge cycle of the battery pack, Thvht is the cumulative time that the battery pack is in the second state during the current charge and discharge cycle, and f3 is the third sub-function.

In some embodiments, if the first parameter includes the number of times that the battery pack is in the third state, using the first function to calculate the discharge cut-off voltage of the battery pack based on the first parameter in the current charge and discharge process of the battery pack may include adjusting the discharge cut-off voltage of the battery pack using a fourth sub-function based on the number of times that the battery pack is in the third state during the current charge and discharge cycle. In some embodiments, the adjusted discharge cut-off voltage of the battery pack may be calculated using the formula: Vterminal=Vterminal0+f4(TVTC), where Vterminal0 is the initial discharge cut-off voltage of the battery pack, TVTC is the number of times that the battery pack is in the third state during the current charge and discharge cycle, and f4 is the fourth sub-function.

In other embodiments, adjusting the discharge cut-off voltage of the battery pack based on the first parameter of the battery pack in the current charge and discharge process may include obtaining the discharge cut-off voltage of the battery pack by querying a first database based on the first parameter of the battery pack in the current charge and discharge process.

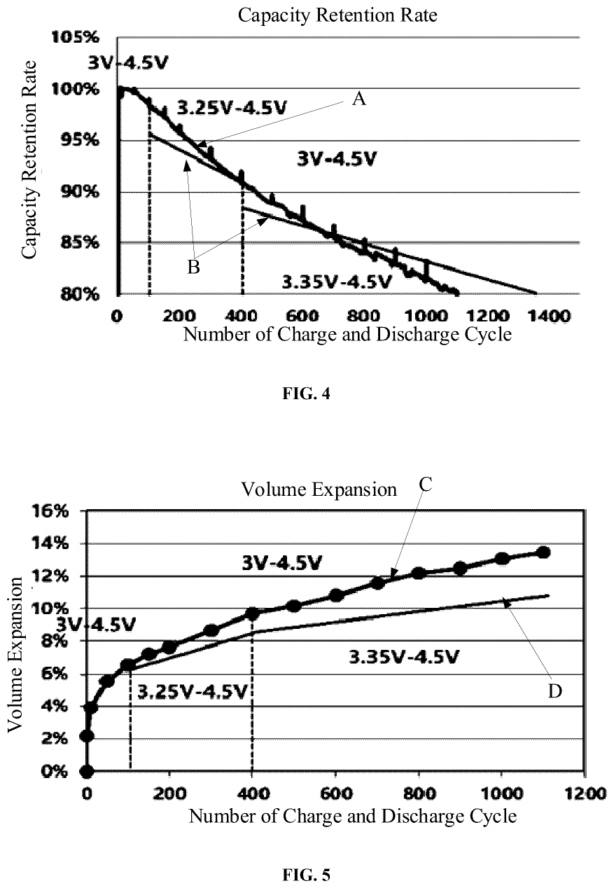

FIG. 4 is a schematic diagram of curves showing a capacity retention rate of the battery pack as a function of a cumulative number of charge and discharge cycles. In FIG. 4, curve A is the discharge cut-off voltage of the battery pack when it remains unchanged during the charge and discharge cycle of the battery pack. Curve B shows the change of the capacity retention rate of the battery pack with the number of charge and discharge cycles when the discharge cut-off voltage of the battery pack is adjusted with the cumulative number of charge and discharge cycles during the charge and discharge cycle of the battery pack. More specifically, in the technical solution corresponding to curve A, the full-charge voltage of the battery pack is 4.5V, and the discharge cut-off voltage is 3V. In the technical solution corresponding to curve B, the full-charge voltage of the battery pack is 4.5V. When the cumulative number of charge and discharge cycles of the battery pack is less than 200, the discharge cut-off voltage of the battery pack is 3V. When the cumulative number of charge and discharge cycles of the battery pack is greater than 200 and less than 400, the discharge cut-off voltage of the battery pack is 3.25V. When the cumulative number of charge and discharge cycles of the battery pack is greater than 400, the discharge cut-off voltage of the battery pack is 3.35V.

By comparing curve A and curve B, it can be seen that after the discharge cut-off voltage of the battery pack is adjusted based on the cumulative charge and discharge cycle of the battery pack, although a certain capacity retention rate will be lost when the cumulative number of charge and discharge cycles of the battery pack is between 200-700, the capacity retention rate of the battery pack will increase when the cumulative number of charge and discharge cycles of the battery pack is greater than 700. In addition, as the cumulative number of charge and discharge cycles of the battery pack increases, the capacity retention rate of the battery pack is improved more significantly, thereby significantly slowing down the attenuation rate of the battery pack and extending the service life of the battery pack.

FIG. 5 is a schematic diagram of curves showing a variation of swelling of a battery cell of the battery pack as a function of the cumulative number of charge and discharge cycles. In FIG. 5, curve C shows the variation of the swelling of a battery cell of the battery pack with the number of the charge and discharge cycles when the discharge cut-off voltage of the battery pack remains unchanged during the charge and discharge cycle of the battery pack. Curve B shows the variation of the cell swelling of the battery pack with the number of charge and discharge cycles when the discharge cut-off voltage of the battery pack is adjusted with the cumulative number of charge and discharge cycles during the charge and discharge cycle of the battery pack. More specifically, in the technical solution corresponding to curve C, the full-charge voltage of the battery pack is 4.5V, and the discharge cut-off voltage is always 3V. In the technical solution corresponding to curve D, the full-charge voltage of the battery pack is 4.5V. When the cumulative number of charge and discharge cycles of the battery pack is less than 200, the discharge cut-off voltage of the battery pack is 3V. When the cumulative number of charge and discharge cycles of the battery pack is greater than 200 and less than 400, the discharge cut-off voltage of the battery pack is 3.25V. When the cumulative number of charge and discharge cycles of the battery pack is greater than 400, the discharge cut-off voltage of the battery pack is 3.35V.

By comparing curve C and curve D, it can be seen that after the discharge cut-off voltage of the battery pack is adjusted based on the cumulative number of charge and discharge cycles of the battery pack, when the cumulative number of charge and discharge cycles of the battery pack is greater than 200, the swelling of the battery cell can be reduced, and as the cumulative number of charge and discharge cycles of the battery pack increases, the swelling of the battery cell is reduced more significantly. Therefore, the technical solutions provided in the embodiments of the present disclosure can significantly reduce the swelling of the battery cells in the battery pack, thereby reducing the risk of battery swelling in the battery pack.

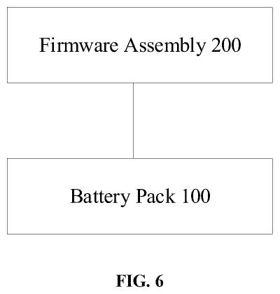

FIG. 6 is a schematic structural diagram of an electronic device according to some embodiments of the present disclosure. The electronic device can be any electronic device that includes a battery pack, such as a mobile phone, a notebook computer, a tablet, a digital broadcast terminal, a messaging device, a game console, a medical device, a wearable device, a fitness device, a personal digital assistant (PDA), a power supply such as an adapter, etc. As shown in FIG. 6, the electronic device includes a battery pack 100 and a firmware assembly 200, and the anode of the battery pack 100 may be a silicon-based anode.

In some embodiments, the firmware assembly 200 may be configured to obtain a first parameter of a battery pack in the electronic device in the current charge and discharge cycle, the first parameter being at least related to the use characteristics of the silicon-based anode; and adjust a discharge cut-off voltage of the battery pack based on the first parameter of the battery pack in the current charge and discharge cycle.

In the electronic device provided in the embodiments of the present disclosure, the firmware assembly may be configured to adjust the discharge cut-off voltage of the battery pack based on the first parameter related to the use characteristic of the silicon-based anode in the battery pack to slow down the attenuation rate of the silicon anode battery and reduce the risk of swelling of the silicon anode battery, thereby extending the service life of the battery pack.

In some embodiments, the electronic device may include a battery management system (BMS), and the firmware assembly may be a part of the BMS. In some cases, the BMS may also be used to detect the first parameter of the battery pack. In this way, the firmware assembly can adjust the discharge cut-off voltage of the battery pack based on the first parameter related to the use characteristics of the silicon-based anode in the battery pack.

In some embodiments, using the firmware assembly to adjust the discharge cut-off voltage of the battery pack based on the first parameter of the battery pack in the current charge and discharge cycle may include increasing the discharge cut-off voltage of the battery pack based on the first parameter of the battery pack in the current charge and discharge cycle to reduce the risk of aging and swelling of the battery pack and improve the capacity retention rate and the cycle life of the battery pack. The capacity retention rate of the battery pack may refer to the percentage of the original capacity that the battery pack can maintain after a certain number of cycles. More specifically, under the same number of cycles, the larger the ratio of the retained capacity to the original discharge capacity, the greater the capacity retention rate of the battery pack and the better the cycle performance.

It should be noted that during the user of the battery pack, the battery pack attenuation may vary with the use time of the battery pack. Therefore, in some embodiments, if the first parameter meets a first condition, the difference between the value of the first parameter and a first value may be different and the increase of the discharge cut-off voltage of the battery pack may be different such that the discharge cut-off voltage of the battery pack can be adjusted based on the current degree of attenuation of the battery pack. In this way, the attenuation rate of silicon anode batteries can be slowed down, the risk of swelling of silicon anode batteries can be reduced, and the service life of the battery pack can be extended.

In some embodiments, the first parameter may include at least one of: the impedance of the battery pack in the first state, the cumulative number of charge and discharge cycles of the battery pack, the cumulative time of the battery pack in the second state, and the number of times the battery pack is in the third state. When the battery pack is in the second state, the voltage of the battery cell in the battery pack may be greater than a first voltage and/or the temperature of the battery cell may be greater than a first temperature. When the battery pack is in the third state, the time during which the operating voltage of the battery pack is lower than the discharge cut-off voltage of the battery pack may not be less than a second preset time.

In some embodiments, when the first parameter includes the impedance of the battery pack in the first state, the first state of the battery pack may be the fully charged state of the battery pack, and the impedance of the battery pack in the first state may be the impedance of the battery pack in the fully charge state. In this way, it is convenient to obtain the first parameter without affecting the user experience, but the present disclosure is not limited hereto. In other embodiments, the first state may also be other states, such as when the battery pack is in the first state, the power of the battery pack is at 70% or 50% or other states.

In some embodiments, the first value may be the impedance of the battery pack when it is in the first state for the first time. In this case, the first condition may be that, during the current charge and discharge cycle, the difference between the impedance of the battery pack in the first state and the first value is greater than a first difference. Take the first state as the fully charged state as an example. The first value may be the impedance of the battery pack when it is in a fully charged state for the first time. In some embodiments, the first condition may include that, during the current charge and discharge cycle, the difference between the impedance of the battery pack when it is fully charged and the first value is greater than a first difference. That is, in this case, during the current charge and discharge cycle, if the difference between the impedance of the battery pack when it is fully charged and the first value is greater than the first difference, the firmware assembly may increase the discharge cut-off voltage of the battery pack to slow down the attenuation rate of the battery pack, reduce the risk of swelling of the silicon anode battery, and extend the service life of the battery pack.

In some embodiments, the first parameter may include the cumulative number of charge and discharge cycles of the battery pack. In this case, the first condition may include the cumulative number of charge and discharge cycles of the battery pack being greater than a first number. That is, in some embodiments, during the current charge and discharge cycle, when the cumulative number of charge and discharge cycles of the battery pack is greater than the first number, based on the difference between the cumulative number of charge and discharge cycles of the battery pack and the first number during the current charge and discharge cycle, the firmware assembly may adjust the discharge cut-off voltage of the battery pack. In this way, the attenuation rate of the battery pack can be slowed down, the risk of swelling of the silicon anode battery can be reduced, and the service life of the battery pack can be extended based on the usage state of the battery pack. In some embodiments, the first number may be zero or other values, which is not limited in the embodiments of the present disclosure and can be set based on actual needs.

In some embodiments, the first parameter may include the cumulative time that the battery pack is in the second state. In this case, the first condition may include the cumulative time that the battery pack is in the second state being greater than a first preset time. That is, in some embodiments, during the current charge and discharge cycle, when the cumulative time that the battery pack is in the second state is greater than the first preset time, the firmware assembly may adjust the discharge cut-off voltage of the battery pack based on the difference between the cumulative time that the battery pack is in the second state and the first value during the current charge and discharge cycle. In this way, the attenuation rate of the battery pack can be slowed down, the risk of swelling of the silicon anode battery can be reduced, and the service life of the battery pack can be extended based on the usage state of the battery pack. In some embodiments, the first value may be zero or other values, which is not limited in the embodiments of the present disclosure and can be set based on actual needs.

In some embodiments, the first parameter may include the number of times the battery pack is in the third state. In this case, the first condition may include the number of times the battery pack is in the third state being not less than a second number. That is, in some embodiments, during the current charge and discharge cycle, when the number of times the battery pack is in the third state is greater than the second number, the discharge cut-off voltage of the battery pack may be adjusted based on the difference between the number of times the battery pack is in the third state and the first number during the current charge and discharge cycle. In this way, the attenuation rate of the battery pack can be slowed down, the risk of swelling of the silicon anode battery can be reduced, and the service life of the battery pack can be extended based on the usage state of the battery pack. In some embodiments, the first value may be zero or other values, which is not limited in the embodiments of the present disclosure and can be set based on actual needs.

In some embodiments, when the first parameter includes the four parameters of the impedance of the battery pack in the first state, the cumulative number of charge and discharge cycles of the battery pack, the cumulative time of the battery pack in the second state, and the number of times the battery pack is in the third state, the first condition may include at least one of the conditions of: during the current charge and discharge cycle, the difference between the impedance of the battery pack when it is in the first state and the first value is greater than the first value, the first value being the impedance of the battery pack when it is in the first state for the first time; during the current charge and discharge cycle, the cumulative number of charge and discharge cycles of the battery pack is greater than the first number; during the current charge and discharge cycle, the cumulative time that the battery pack is in the second state is greater than the first preset time; during the current charge and discharge cycle, the number of times that the battery pack is in the third state is greater than the second number.

It should be noted that in the foregoing embodiments, during the use of the electronic device, the discharge cut-off voltage of the battery pack may be adjusted if the usage state of the battery pack meets at least one of the four conditions of: during the current charge and discharge cycle, the difference between the impedance of the battery pack in the first state and the first value is greater than the first value, the first value being the impedance of the battery pack when it is in the first state for the first time; during the current charge and discharge cycle, the cumulative number of charge and discharge cycles of the battery pack is greater than the first number; during the current charge and discharge cycle, the cumulative time that the battery pack is in the second state is greater than the first preset time; during the current charge and discharge cycle, the number of times that the battery pack is in the third state is greater than the second number.

In some embodiments, using the firmware assembly to adjust the discharge cut-off voltage of the battery pack based on the first parameter of the battery pack in the current charge and discharge cycle may include calculating the discharge cut-off voltage of the battery pack using the first function based on the first parameter of the battery pack in the current charge and discharge cycle. In other embodiments, using the firmware assembly to adjust the discharge cut-off voltage of the battery pack based on the first parameter of the battery pack in the current charge and discharge cycle may also include obtaining the discharge cut-off voltage of the battery pack by querying a first database based on the first parameter of the battery pack in the current charge and discharge process.

Consistent with the present disclosure, in the electronic device provided in the present disclosure, the firmware assembly can adjust the discharge cut-off voltage of the battery pack based on the first parameter related to the usage characteristics of the silicon-based anode in the battery pack to slow down the attenuation rate of the silicon anode battery and reduce the risk of swelling in the silicon anode battery, thereby increasing the service life of the battery pack, realizing the first landing of ultra-high energy density batteries, and enhancing the competitiveness of thin and lightweight products.

In the present specification, the embodiments are described in a gradual and progressive manner with the emphasis of each embodiment on an aspect different from other embodiments. The same or similar parts among the various embodiments may refer to each other. Since the disclosed device embodiment corresponds to the disclosed method embodiment, detailed description of the disclosed device is omitted, and reference can be made to the description of the methods for a description of the relevant parts of the device.

Above description of disclosed embodiments may enable those skilled in the art to make or use the present disclosure. Various modifications to these embodiments may be readily apparent to those skilled in the art, and the generic principles defined herein may be implemented in other embodiments without departing from the spirit or scope of the present disclosure. Therefore, the present disclosure may not be intended to be limited to embodiments of the present disclosure but may be accorded the widest scope consistent with the principles and novel features disclosed herein.

What is claimed is:

1. An information processing method, applied to an electronic device, the electronic device including a battery pack, an anode of the battery pack being a silicon-based anode, the method comprising:
obtaining a first parameter of the battery pack in the electronic device in a current charge and discharge cycle, the first parameter being at least related to use characteristics of the silicon-based anode; and
adjusting a discharge cut-off voltage of the battery pack based on the first parameter of the battery pack in the current charge and discharge cycle.

2. The information processing method of claim 1, wherein:
if the first parameter meets a first condition, a difference between a value of the first parameter and a first value is different, and an increase range of the discharge cut-off voltage of the battery pack is different, wherein:
the increase range of the discharge cut-off voltage of the battery pack increases linearly with the increase of the difference between the value of the first parameter and the first value; or,
the increase range of the discharge cut-off voltage of the battery pack increases non-linearly with the increase of the difference between the value of the first parameter and the first value.

3. The information processing method of claim 2, wherein:
the first parameter includes at least one of an impedance of the battery pack in a first state, a cumulative number of charge and discharge cycles of the battery pack, a cumulative time of the battery pack in a second state, and a number of times the battery pack is in a third state, wherein:
when the battery pack is in the second state, a voltage of a battery cell in the battery pack is greater than a first voltage and/or temperature of the battery cell is greater than a first temperature;
when the battery pack is in the third state, the time during which an operating voltage of the battery pack is lower than the discharge cut-off voltage is not less than a second preset time.

4. The information processing method of claim 3, wherein:
when the first parameter includes the impedance of the battery pack in the first state, the impedance of the battery pack in the first state is an impedance of the battery pack in a fully charged state.

5. The information processing method of claim 2, wherein:
the first value is the impedance of the battery pack when it is in the first state for a first time; and
the first condition includes, in the current charge and discharge cycle, the difference between the impedance of the battery pack when it is in the first state and the first value is greater than a first difference.

6. The information processing method of claim 3, wherein:
the first parameter includes the cumulative number of charge and discharge cycles of the battery pack, and the first condition includes the cumulative number of charge and discharge cycles of the battery pack being greater than a first number.

7. The information processing method of claim 3, wherein:
the first parameter includes the cumulative time that the battery pack is in the second state, and the first condition includes the cumulative time that the battery pack is in the second state is greater than a first preset time.

8. The information processing method of claim 3, wherein:
when the first parameter includes the impedance of the battery pack in the first state, the cumulative number of charge and discharge cycles of the battery pack, the cumulative time that the battery pack is in the second state, and the number of times when the battery pack is in the third state, the first condition includes at least one of:
during the current charge and discharge cycle, the difference between the impedance of the battery pack when it is in the first state and the first value is greater than the first difference, and the first value is the impedance of the battery pack when it is in the first state for the first time;
during the current charge and discharge cycle, the cumulative number of charge and discharge cycles of the battery pack is greater than the first number;
during the current charge and discharge cycle, the cumulative time that the battery pack is in the second state is greater than the first preset time; and
during the current charge and discharge cycle, the number of times the battery pack is in the third state is greater than a second number.

9. An electronic device, the electronic device including a battery pack and a firmware assembly, an anode of the battery pack being a silicon-based anode, the firmware assembly being configured to:
obtain a first parameter of the battery pack in the electronic device in a current charge and discharge cycle, the first parameter being at least related to use characteristics of the silicon-based anode; and
adjust a discharge cut-off voltage of the battery pack based on the first parameter of the battery pack in the current charge and discharge cycle.

10. The electronic device of claim 9, wherein:
the first parameter includes at least one of: an impedance of the battery pack in a /f1, a cumulative number of charge and discharge cycles of the battery pack, a cumulative time of the battery pack in a second state, and a number of times the battery pack is in a third state, wherein:
when the battery pack is in the second state, a voltage of a battery cell in the battery pack is greater than a first voltage and/or temperature of the battery cell is greater than a first temperature;
when the battery pack is in the third state, the time during which an operating voltage of the battery pack is lower than the discharge cut-off voltage is not less than a second preset time.

11. A computer readable storage medium storing one or more computer instructions, when executed by one or more processors, the computer instructions implementing an information processing method applied to an electronic device, the electronic device including a battery pack, an anode of the battery pack being a silicon-based anode, the method comprising:
obtaining a first parameter of the battery pack in the electronic device in a current charge and discharge cycle, the first parameter being at least related to use characteristics of the silicon-based anode; and
adjusting a discharge cut-off voltage of the battery pack based on the first parameter of the battery pack in the current charge and discharge cycle.

12. The computer readable storage medium of claim 11, wherein:
if the first parameter meets a first condition, a difference between a value of the first parameter and a first value is different, and an increase range of the discharge cut-off voltage of the battery pack is different, wherein:
the increase range of the discharge cut-off voltage of the battery pack increases linearly with the increase of the difference between the value of the first parameter and the first value; or,
the increase range of the discharge cut-off voltage of the battery pack increases non-linearly with the increase of the difference between the value of the first parameter and the first value.

13. The computer readable storage medium of claim 12, wherein:
the first parameter includes at least one of an impedance of the battery pack in a first state, a cumulative number of charge and discharge cycles of the battery pack, a cumulative time of the battery pack in a second state, and a number of times the battery pack is in a third state, wherein:
when the battery pack is in the second state, a voltage of a battery cell in the battery pack is greater than a first voltage and/or temperature of the battery cell is greater than a first temperature;
when the battery pack is in the third state, the time during which an operating voltage of the battery pack is lower than the discharge cut-off voltage is not less than a second preset time.

14. The computer readable storage medium of claim 13, wherein:
when the first parameter includes the impedance of the battery pack in the first state, the impedance of the battery pack in the first state is an impedance of the battery pack in a fully charged state.

15. The computer readable storage medium of claim 12, wherein:
the first value is the impedance of the battery pack when it is in the first state for a first time; and
the first condition includes, in the current charge and discharge cycle, the difference between the impedance of the battery pack when it is in the first state and the first value is greater than a first difference.

16. The computer readable storage medium of claim 13, wherein:
the first parameter includes the cumulative number of charge and discharge cycles of the battery pack, and the first condition includes the cumulative number of charge and discharge cycles of the battery pack being greater than a first number.

17. The computer readable storage medium of claim 13, wherein:
the first parameter includes the cumulative time that the battery pack is in the second state, and the first condition includes the cumulative time that the battery pack is in the second state is greater than a first preset time.

18. The computer readable storage medium of claim 13, wherein:
when the first parameter includes the impedance of the battery pack in the first state, the cumulative number of charge and discharge cycles of the battery pack, the cumulative time that the battery pack is in the second state, and the number of times when the battery pack is in the third state, the first condition includes at least one of:
during the current charge and discharge cycle, the difference between the impedance of the battery pack when it is in the first state and the first value is greater than the first difference, and the first value is the impedance of the battery pack when it is in the first state for the first time;
during the current charge and discharge cycle, the cumulative number of charge and discharge cycles of the battery pack is greater than the first number;
during the current charge and discharge cycle, the cumulative time that the battery pack is in the second state is greater than the first preset time; and
during the current charge and discharge cycle, the number of times the battery pack is in the third state is greater than a second number.
